(19) United States
(12) Patent Application Publication
(10) Pub. No.: US 2011/0166997 A1
(43) Pub. Date: Jul. 7, 2011

(54) PROXY-BASED PAYMENT SYSTEM

(75) Inventors: Philip B. Dixon, San Diego, CA (US); Pradip Mistry, San Diego, CA (US); David L. deKozan, San Diego, CA (US)

(73) Assignee: Cubic Corporation, San Diego, CA (US)

(21) Appl. No.: 12/833,258

(22) Filed: Jul. 9, 2010

Related U.S. Application Data
(60) Provisional application No. 61/224,418, filed on Jul. 9, 2009.

(51) Int. Cl. G06Q 20/00; G06K 19/073; G06Q 40/00

(52) U.S. Cl. 705/41; 235/492; 235/379

(57) ABSTRACT

A system, method, and apparatus for accepting account-based contactless smartcards at offline terminals are disclosed. The contactless smartcards may be branded bank cards which have a prepaid account balance. Each card may include an integrated circuit with a payment application, a proxy application, and a proxy data store. A proxy-enabled card reader can read and write the proxy data and may use the proxy data to determine whether to proceed with a card-based transaction absent an online authorization. Updated proxy information may be periodically distributed throughout a payment system and used to update various lists maintained at the card readers.

### CROSS-REFERENCES TO RELATED APPLICATION

This application claims the benefit of and is a non-provisional of U.S. Provisional Patent Application Ser. No. 61/224,418, filed Jul. 9, 2009, which is incorporated herein by reference for all purposes.

The present application is also related to U.S. patent application Ser. No. ______ (Attorney Docket No. 014801-012610US) entitled “Predictive Techniques in Transit Alerting;” U.S. patent application Ser. No. ______ (Attorney Docket No. 014801-012710US) entitled “ID Application for NFC Phone;” U.S. patent application Ser. No. ______ (Attorney Docket No. 014801-012810US) entitled “Transit Account Management With Text Messaging,” and U.S. patent application Ser. No. ______ (Attorney Docket No. 014801-013010US) entitled “Reloadable Prepaid Card Distribution, Reload, and Registration in Transit,” all of which are filed concurrently herewith and incorporated herein by reference for all purposes.

### BACKGROUND

Contactless smartcards represent a convenient form of payment and have become widely accepted in the marketplace. Because they communicate wirelessly, contactless smartcards can be used purchase a variety of goods and services without even being removed from a purse or wallet.

Unfortunately, due to this convenience and the rapid nature of card-based transactions, contactless smartcards may present a number of challenges to merchants and payment system operators. Fraudulent use may be of particular concern. Such fraudulent use may include the use of stolen cards or deliberate attempts to exploit a payment system or to bypass its security measures.

### BRIEF SUMMARY

A system, method, and apparatus for accepting account-based contactless smartcards at offline terminals are disclosed. The contactless smartcards may be branded bank cards which have a prepaid account balance. Each card may include an integrated circuit with a payment application, a proxy application, and a proxy data store. A proxy-enabled card reader can read and write the proxy data and may use the proxy data to determine whether to proceed with or decline a card-based transaction. Updated proxy information may be periodically distributed throughout a payment system and used to update various lists maintained at the card readers.

In one embodiment, a contactless smartcard is disclosed. The contactless smartcard includes an antenna adapted to receive magnetic field emissions in a frequency band associated with a card reader. The contactless smartcard also includes an integrated circuit which is coupled to the antenna and operative to communicate with the card reader according to a contactless smartcard communication protocol. The integrated circuit includes a payment module configured to access account information comprising a bank identification number and to exchange the account information with the card reader in connection with a bank card transaction. The integrated circuit includes a data store configured to maintain proxy data comprising an estimated account balance corresponding to the account information and at least one data element relating to use of a transit system. The integrated circuit also includes a proxy module configured to access the proxy data and to update the estimated account balance and the at least one data element in response to commands from the card reader.

In another embodiment, a method of accepting contactless smartcards as payment for a transaction at an offline terminal is disclosed. The method includes detecting a contactless smartcard at the offline terminal, obtaining a bank identifier and account information from the contactless smartcard, and obtaining an estimated account balance corresponding to the account information from an updateable storage area of the contactless smartcard. The method also includes comparing the estimated account value with a transaction amount and determining whether to proceed with the transaction based on a result of the comparison. The method may also include obtaining an updated account balance representing a prepaid account balance associated with the account information and writing the updated account balance to the contactless smartcard in connection with the transaction.

In yet another embodiment, a card reader is disclosed. The card reader includes a radio-frequency (RF) interface configured to communicate with a contactless smartcard and a processor coupled to the RF interface. The processor is configured to obtain account information comprising a bank identification number from the contactless smartcard and determine an availability of proxy data at the contactless smartcard and obtain an estimated account balance from the proxy data. The processor is also configured to compare the estimated account balance with a transaction amount and proceed with the transaction based on a result of the comparison. In some embodiments, the card reader includes a network interface configured to receive information corresponding to the account information of the contactless smartcard from a host computer, to determine an estimated balance for the contactless smartcard based on the received information, and to update the proxy data at the contactless smartcard using the estimated balance. Optionally, the card reader includes a data storage element and the processor is configured to receive an updated balance corresponding to the account information using the network interface and to store the updated balance in the data storage element.

Additional aspects of the invention will become apparent in the course of the following description and with reference to the accompanying drawings.

### BRIEF DESCRIPTION OF THE DRAWINGS

FIG. 1A shows one embodiment of a payment processing system.

FIG. 1B shows aspects of payment processing for contactless bank cards.

FIG. 2 shows an embodiment of a proxy-enabled contactless smartcard.

FIG. 3 shows an embodiment of an integrated circuit for a contactless smartcard.

FIG. 4 shows exemplary account information for a contactless smartcard.

FIG. 5 shows exemplary proxy data for a contactless smartcard.

FIG. 6 shows an embodiment of a proxy-enabled card reader.

FIG. 7 shows an embodiment of a proxy based payment process.

FIG. 8 shows an embodiment of an proxy data update process.

FIG. 9 shows an embodiment of a proxy based payment verification process.

In the figures, similar components and/or features may have the same reference label. In some cases, components of the same type are identified by following the reference label with a dash and a second label that further distinguishes among the similar components. If only the first reference label is used, the description is applicable to any of the similar components designated by the first reference label.

### DETAILED DESCRIPTION OF EMBODIMENTS

The ensuing description provides preferred exemplary embodiment(s) only, and such preferred exemplary embodiments are not intended to limit the scope or applicability of the present invention. Rather, the ensuing description will enable those who are skilled in the art to implement such preferred exemplary embodiment(s). Persons of skill in the art will recognize that various changes may be made in the function and arrangement of elements without departing from the spirit and scope of the invention as set forth in the appended claims.

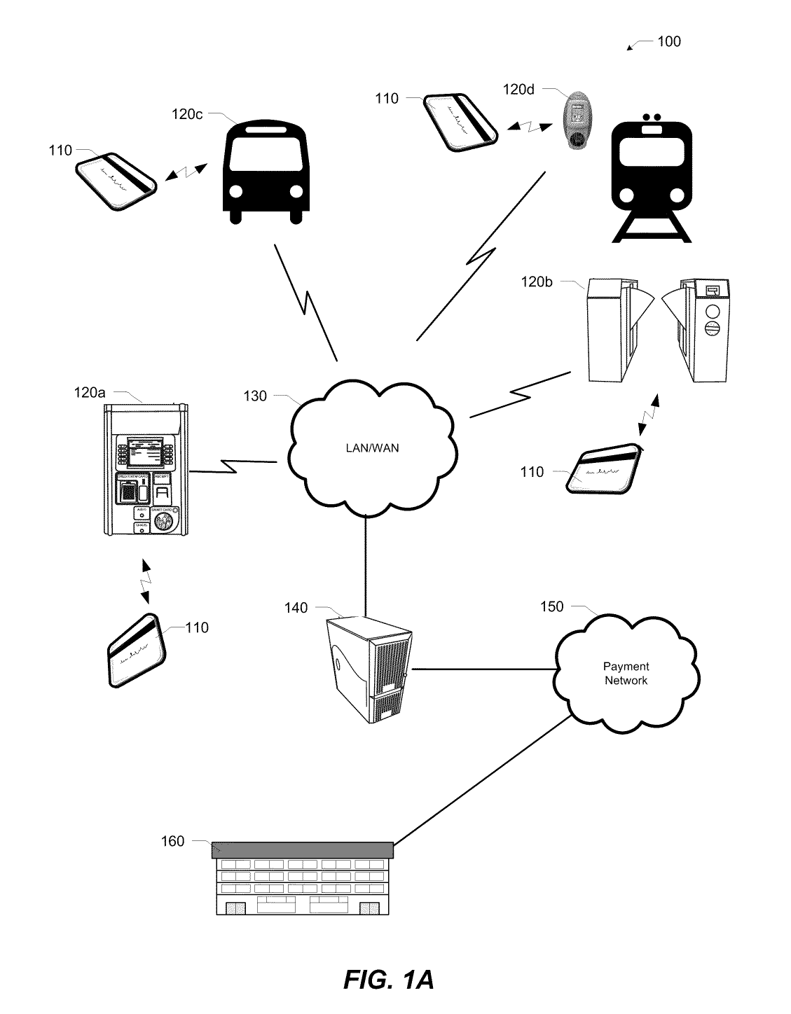

FIG. 1A shows an embodiment of a payment system 100. Payment system 100 includes a plurality of terminals 120 in data communication with contactless smartcards 110. Contactless smartcards 110 (also referred to as “smartcards” or “cards”) can be bank cards which are used to make generalized purchases. Each bank card is associated with an account at a card issuer and may carry one of the Visa, MasterCard, American Express, Discover, or Eurocard brands. The accounts may be credit, debit, or prepaid-value accounts.

It will be understood that the system, method, and apparatus disclosed herein are not limited to cards and smartcards. The media fare used by a patron or consumer could be in the form of a card, or could have one of a variety of form factors like a watch, fob, or token. Mobile devices may also be utilized, by using near-field communication (NFC) technology, for example. Other forms of fare media are also contemplated.

Terminals 120 can be a variety of card reader devices which are capable of conducting transactions with contactless smartcards 110. For example, terminals 120 may be point-of-sale devices such as vending machines, 120a, fare gates, 120b, fare boxes, 120c, or other ticket and payment processing devices, 120d.

Network 130 connects terminals 120 to a central computer 140. Network 130 can be a local area network (LAN), a wide area network (WAN), the internet, or any combination thereof. Terminals 120 provide information about smartcard transactions to the central computer 140 and receive information for conducting card transactions from the central computer 140 over network 130. For example, payment system 100 can be a transit system in which central computer 140 administers ticket sales and fare collection operations.

As shown, central computer 140 is also coupled to card issuers 160 via a payment network 150. Payment network 150 can include multiple elements involved in processing bank card transactions such as acquisition systems, brand switches, and related entities. Card issuers 160 maintain account information and are responsible for authorizing transactions involving the cards they issue. With credit cards, for example, a card issuer 160 may authorize a transaction if the associated account is in good standing, or decline the transaction if the account has not be paid. Similarly, a card issuer 160 may authorize a debit or prepaid transaction if the account contains sufficient funds and decline the transaction otherwise.

FIG. 1B shows details of an exemplary online authorization process for payment system 100. As illustrated, a contactless smartcard 110 originates a transaction at a POS terminal 120. POS terminal 120 sends an authorization request or balance check with account information (such as a bank account number) through the system to a card issuer 160. The card issuer 160 verifies the account information and sends a response back to the POS terminal. This process typically takes between 2-18 seconds and presupposes a real-time exchange of information.

Unfortunately, card-based transactions must be completed much more rapidly in some payment systems in order to avoid disruption. For example, in a transit system, ticketing transactions should take no longer than 500 ms to complete in order to avoid excessive queuing and to ensure buses and trains operate on schedule.

To further complicate matters, many terminals 120 lack the ability to go online and make real-time authorization requests. For example, bus and taxi-based terminals may simply not have access to the payment network 150 at all times. Rather than requesting a real-time authorization, they may perform offline transactions and store them for processing at a later time. As used herein, an “offline transaction” refers to a contactless smartcard transaction for which online authorization from a card issuer is not obtained. An “offline terminal” refers to a card reading device which conducts offline transactions. Offline terminals may or may not be capable of making a real-time authorization request or balance checks.

Offline transactions represent a risk for merchants and other payment system operators. On the one hand, it may be desirable to accept bank-issued cards as a form of payment at offline terminals. This provides customers with added convenience and avoids the need for special-purpose payment cards. On the other hand, offline terminals lack the ability to verify account balances and thus the merchant may risk losses by accepting a card as payment for goods or services without first obtaining authorization from the card issuer.

According to the present embodiment, terminals 120 and smartcards 110 include a proxy capability which can be used in connection with offline or other card transactions. Smartcards 110, particularly prepaid and general purpose reloadable (GPR) cards, may include a proxy data store and a proxy application. The proxy data store may include a representation of the account balance at a card issuer that is accessible to offline terminals 120 in connection with contactless smartcard transactions.

When a proxy-enabled smartcard 110 is presented at an offline terminal, for example, the terminal 120 may read account information such as a bank identifier and primary account number (PAN) from the card. The terminal 120 may then determine if additional verification of the account balance is required. If additional verification is required, the terminal may issue appropriate commands to retrieve the representation of the account balance stored on the card. The representation of the account balance and other proxy information may be stored on the card in an encrypted form.

Terminals 120 may compare the representation of the account balance with an amount of the transaction. Since the actual account balance is not immediately verified, terminals 120 may apply business rules to determine whether to proceed with a particular transaction. For example, a transaction may be approved if the estimated account balance is at least $25 and if the proxy information suggests that the card has not been used in card in the last 3 days. Alternatively, the transaction may be approved if the cardholder has established an account with the payment system operator, or based on some other criteria. If the transaction is approved, the terminal 120 may adjust the estimated account balance accordingly and write the new amount back to the proxy data store.

Central computer 140 may collect updated account balance information from card issuers 160. When terminals 120 go online, they may upload card transaction data to central computer 140. Central computer 140 may also download the updated account balance information to terminals 120 for use with future transactions. If the updated account balance information indicates a low-balance condition for a card or that a card is no longer in good standing with the issuer, terminals 120 may add the card information to a negative list so that future transactions can be automatically declined.

Advantageously, with proxy-enabled smartcards and terminals, bank card transactions can be accepted at offline terminals with a reduced risk of non-payment. Proxy data can also be utilized to provide proof-of-payment within payment system 100 without a complex transit application and/or fare processing logic. Lastly, as shown in FIG. 1B, lists and updated account balance information at terminals 120 are typically accessible in less than 500 ms thereby achieving operational goals, minimizing the potential for service disruptions, and improving the overall user experience of payment system 100.

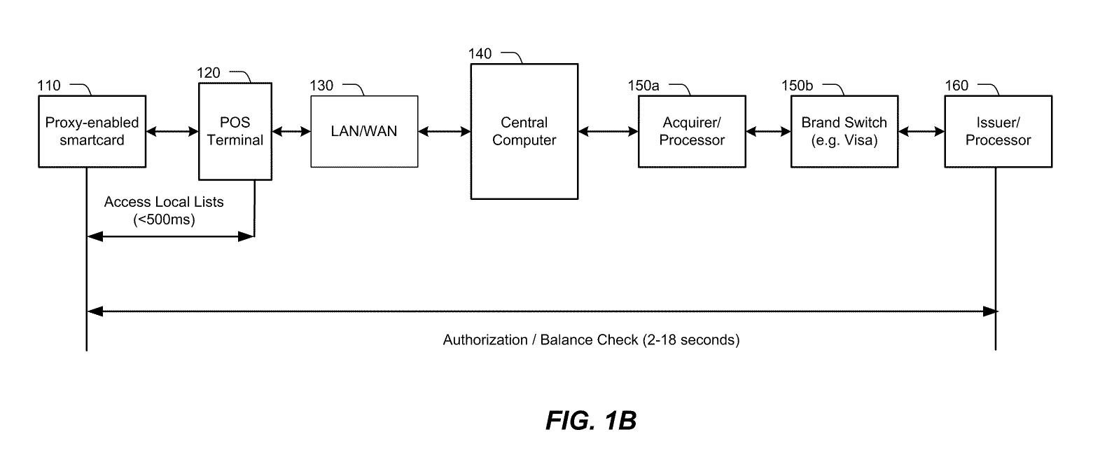

FIG. 2 shows a proxy-enabled contactless smartcard 200 such as can be used in payment system 100. Contactless smartcard 200 is a bank card and is linked with an account at a card issuer for making general purchases. As previously indicated, contactless smartcard 200 may be a branded product such as a Visa, MasterCard, American Express, Discover, or like payment card.

Smartcard 200 includes an antenna 210 and tuning circuitry sensitive magnetic field emissions in a frequency band associated with card reading devices such as terminals 120. In various embodiments, smartcard 200 communicates according to ISO 14443 standards for proximity cards and may operate at a frequency of approximately 13.56 MHz.

An integrated circuit 220 is coupled to the loop antenna 210 and includes a communications module 230 and a proxy module 240. Communications module 230 controls communication with a card reader according to a contactless smartcard (CSC) communication protocol. For example, communications module 230 may control a load modulation of the magnetic field emissions from terminals 120. With some ISO 14443 cards (Type A), modulation may take the form of amplitude modulation at a predetermined sub-carrier frequency. Communications module 240 may also communicate with other types of cards through phase modulation or a combination of modulation techniques.

Proxy module 240 can be configured to manage a proxy data store of integrated circuit 220. In some embodiments, proxy module 240 authenticates card readers (such as terminals 120) and controls access to encrypted proxy data. Unlike conventional contactless bank cards which are typically read-only devices, proxy module 240 may respond to commands from authenticated card readers to both read information from and write information to the proxy data store.

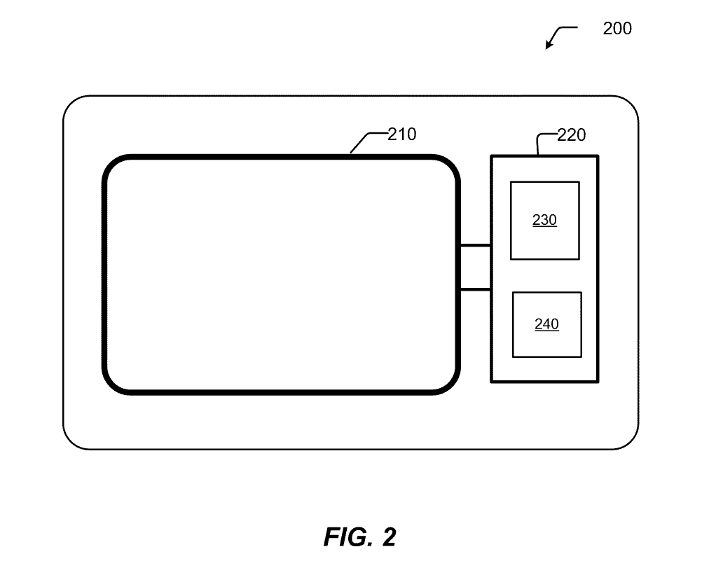

FIG. 3 shows one embodiment of a proxy-enabled integrated circuit 300 such as can be used with contactless smartcard 200. For a clear understanding of its operation, integrated circuit 300 is shown as having a plurality of elements. However, it will be recognized that the elements shown may be combined or separated into various circuit blocks and/or implemented as fixed instructions which are executed by a processor.

A physical (PHY) and medium access control (MAC) layer 310 receives electrical signals from loop antenna 210 and provides data frames for processing at a CSC protocol layer 320. The CSC protocol layer 320 extracts data from the frames and interprets card reader commands. A payment application 330 is coupled to the CSC protocol layer 320 and controls access to account information used to make purchases. For example, payment application 330 may implement a brand-specific payment protocol.

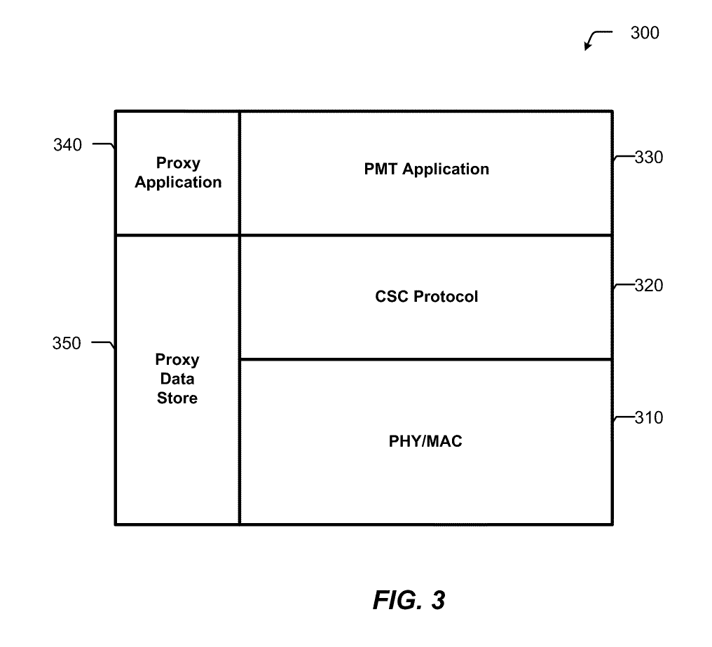

FIG. 4 shows exemplary account information 400 such as can be managed by payment application 330. Account information 400 may be similar to track data used with magnetic stripe cards and may include, among other things, an account number 410, and expiration date 420, a service code 430, and discretionary data 440.

The account number 410 may include the personal account number (PAN) for a credit, debit, or prepaid account with a card issuer. Typically, the first portion of the account number includes a bank identification number (BIN). The expiration date 420 provides an indication of whether the account remains active at the issuer. The service code can include multiple parts which signal restrictions applicable to the account. Examples of restrictions on card usage can include whether a PIN number is required to make transactions, and whether a card can be used to obtain a cash advance. Discretionary data 440 may include a card verification key (CVK) or other security related and/or fraud prevention data.

Integrated circuit 300 also includes a proxy application 340 which controls access to information in a proxy data store 350. Proxy application 340 receives requests to read and write proxy data and can be used to obtain an estimated balance associated with account information 400, to document a purchase made with the contactless smartcard, and to track other information relevant to card usage.

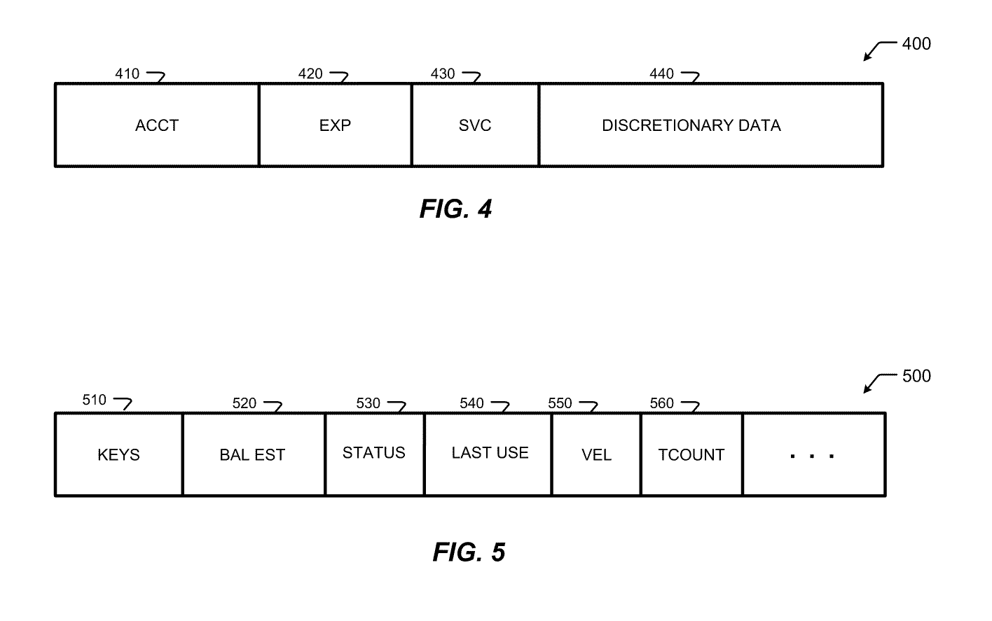

FIG. 5 shows exemplary proxy data 500 such as can be maintained in proxy data store 350. Proxy data 500 can include, among other things, cryptographic keys or variables 510, an estimated balance 520, status information 530, last usage data 540, a velocity indicator 550, and a transaction counter 560.

Cryptographic keys or variables 510 can be used with a triple DES or other suitably strong encryption algorithm to authenticate a card reader and to protect proxy data 500 from tampering. Estimated balance 520 can provide an indicator of the balance associated with account information 400. For example, estimated balance 520 may reflect the balance in a prepaid or reloadable account identified by account number 410 at a particular point in time. The estimated balance 520 may be updated periodically based on information obtained from a card issuer 160 or from other points in a payment system. Status information 530 can be used to disable use of a smartcard such as when an account is no longer in good standing with a card issuer, has a low balance condition, has been reported stolen, etc.

Last use information 540 can provide an indication of when a contactless smartcard was last received as payment for services. For example, in a transit system, last use information 540 may reflect a time and place when a contactless smartcard 110 was used to pay a fare and may serve as proof-of-payment at other points within the transit system. Velocity indicator 550 may reflect a number of uses of the card in a predetermined interval. Excessive usage may indicate fraud or a theft of services. Velocity indicator 550 may also be used in conjunction with status information 530 to disable a suspect card within a payment system.

Transaction counter 560 can be used in a payment system to track card activity and to facilitate back end processing operations, particularly those performed at offline terminals. For example, in a transit system, calculating a fare may require construction of a virtual trip from several travel segments. Transaction counter 560 can improve the accuracy of fare calculation by providing an indication of the number of times or the sequence in which a card is used in the payment system.

When communicating with a card reader, integrated circuit 300 passes commands and data up through the layers to the payment and/or proxy applications. In a proxy-enabled transaction, proxy application 340 responds to requests for data in proxy data store 350 from the CSC protocol layer 320 by authenticating the requestor through an exchange of cryptographic keys or variables 510. Thereafter, proxy application 340 may respond to card reader commands for the status 530 or estimated balance 520 which, in turn, may be used to determine whether the account information supplied by payment application 330 is accepted or whether the transaction will be declined.

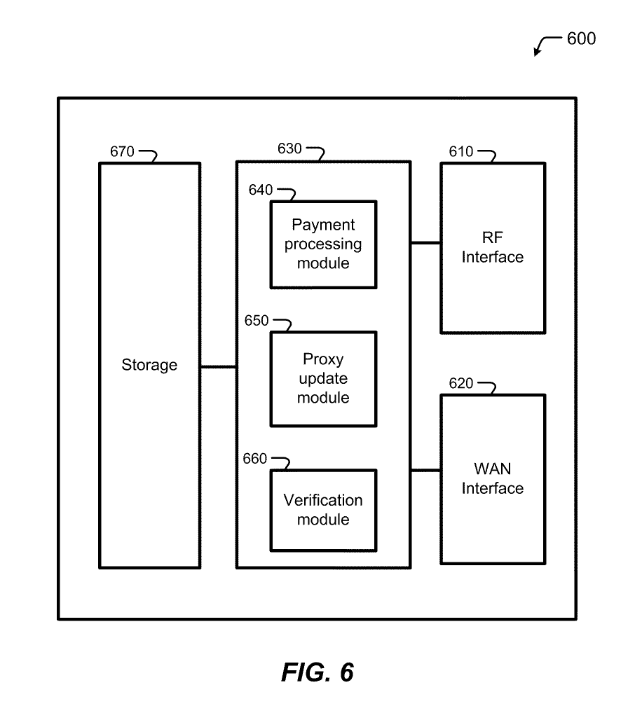

FIG. 6 shows an embodiment of card reader 600. Card reader 600 can be used in payment system 100 and may be a point-of-sale terminal that accepts payment from contactless smartcards. Card reader 600 may also be a used to verify contactless smartcard transactions such as a handheld ticketing device.

As shown, card reader 600 includes an RF interface 610, a WAN interface 620, a processor 630, and a storage 670. RF interface 610 can be configured to communicate with contactless smartcards according to a CSC protocol. WAN interface 620 can support network communications with a central host computer (such as central computer 140) and/or card issuer (such as card issuer 160). However, it should be noted that card reader 600 is capable of operating in an offline mode in which network communication is not required in order to perform sales or related transactions.

A processor 630 is coupled to RF interface 610 and WAN interface 620 for controlling various operations of card reader 600. In the present embodiment, processor 630 includes modules 640, 650, 660 for carrying out different functions of card reader 600. Processor 630 is also coupled to storage element 670. Storage element 670 may include computer-readable storage media such as random access memory, read-only memory, magnetic storage, optical storage, solid state storage, and the like. Storage element 670 may also include data and program instruction which, when executed by processor 630, carry out various operations of card reader 600 as described herein.

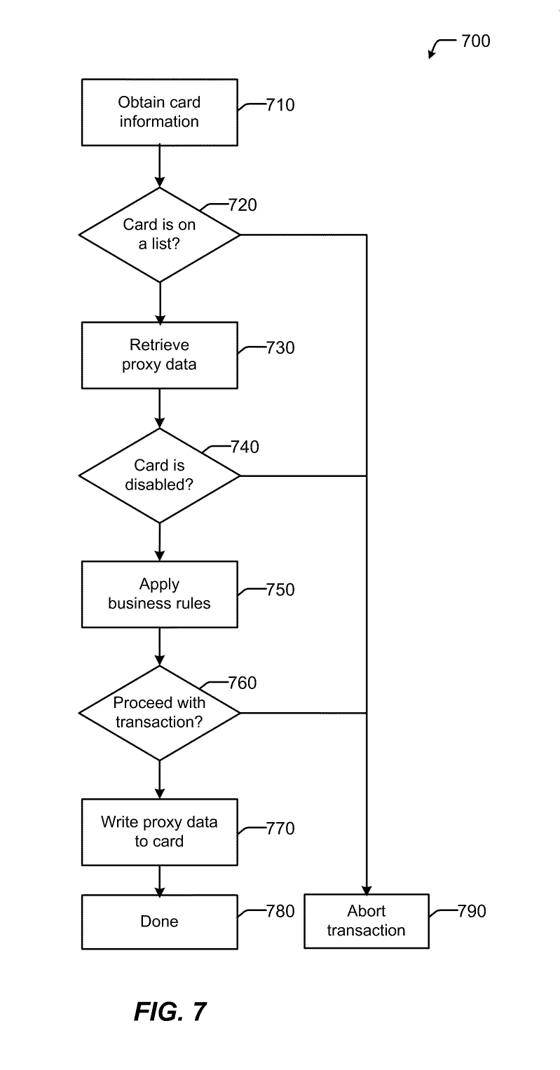

FIG. 7 shows an embodiment of a process 700 for conducting a proxy-enabled card transaction such as can be performed by payment processing module 640 of processor 630. At block 710, card reader 600 obtains account information from a contactless smartcard. This may involve reader a bank identification number from the card and verifying the card's expiration date.

At block 720, payment processing module 640 determines whether the card information appears on one or more lists. In various embodiments of card reader 600, storage element 670 includes lists of card identifiers which facilitate transaction processing. These may include a negative list and positive list for which regular updates may be received from the payment system operator at WAN interface 620. If the card information is found on a negative list, payment processing branches to block 790 and the transaction is aborted.

Proxy data may be retrieved at block 730 for use in the transaction. This may be particularly useful as a risk reduction measure when performing offline transactions. Payment processing module 640 may determine whether to use proxy data based on a number of factors.

As one approach, payment processing module 640 can examine the bank identification portion of PAN 410 and request proxy data when it detects that the card is issued by an affiliated financial institution. An affiliated financial institution could be a bank or card issuer which has entered into an agreement with the payment system operator to furnish account balance information for some or all of its cards. Thus, for example, payment processing module 640 may request proxy data from cards for which the BIN is “1234.”

As an another approach, payment processing module 640 may request proxy data based on restrictions indicated by SVC code 430. In some cases, certain SVC restrictions may be used with prepaid value cards. Upon detecting such restrictions, payment processing module 640 may require proxy data from the card in order to continue with the transaction. If proxy data is not available, the transaction may be aborted or other risk reduction measures may be taken.

At block 740, using the proxy data, payment processing module 640 determines whether use of the card has been disabled in the payment system. This may involve reading status indicator 530. If payment processing module 640 determines that the card has been disabled, it may update one or more of the lists in storage 670. For example, disabled cards may be added to the negative list. In some embodiments, the process may also be reversed. In particular, when a card which appears on the negative list is presented as payment, card reader 600 updates status indicator 530 to disable further use of the card and then removes the card information from its negative list. Thus, with the aid of proxy data, it is possible to reduce the size of internal lists.

At block 750, business rules are applied to decide whether the transaction should be allowed. Business rules may be applied to any combination of information retrieved from the proxy data. In the simplest case, payment processing module 640 may compare the purchase amount with estimated balance 520 and allow the transaction to proceed if there appear to be sufficient funds. In some cases, the transaction may be allowed to continue if estimated balance 520 exceeds a predetermined threshold or a combination of a threshold value and time of last use.

As mentioned previously, proxy data may also be used to facilitate backend processing of the transaction. For example, the transaction counter 560 may be stored with the transaction details and used in a final fare determination. Similarly, proxy data may include cardholder identifiers which can be used with applicable business rules to provide discounts and other incentives such as enabling a reduced fare for elderly riders of a transit system. Many variations are possible within the scope of the present disclosure.

Following application of the business rules, at block 760, the transaction is either allowed to proceed or it is declined. If the transaction is declined, the process ends at block 790. However, if the transaction is permitted to continue, proxy data may be written back to the card at block 770. This may include updating estimated balance 520 to reflect the amount of the purchase prices, as well as updating last use information 540, velocity data 550, and the transaction counter 560. Depending upon the business rules, status indicator 530 may also be changed to disable further use of the card in the payment system. Processing is complete at block 780.

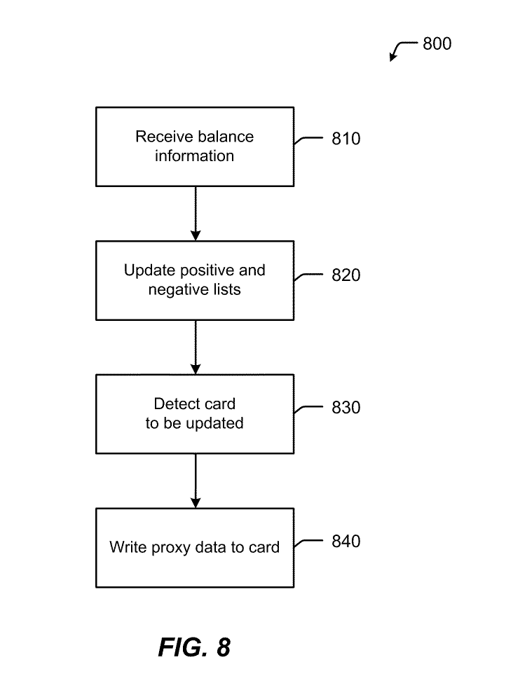

FIG. 8 shows an embodiment of an update process 800 such as can be performed by the proxy update module 650 of processor 630. At block 810, card reader 600 receives updated balance information. The updated information may provided periodically by card issuers or upon request from a payment system operator. Card reader 600 may receive updates at WAN interface 620 and store the updated information locally pending its distribution to proxy-enabled cards.

At block 820, proxy update module 650 may process the balance information and update one or more lists in storage element 670. This may include adding accounts which are no longer in good standing with a card issuer to the negative list and either removing cards from the negative list or adding them to a positive list based on balance and other information from the card issuer or payment system operator.

At block 830, cards are detected at card reader 600. This may occur as cards are presented as payment or offered as proof of a prior payment. When updates are available, at block 840 proxy update module 650 manages the authentication process including the exchange of cryptographic keys or variables 510 and issues commands for writing the updated information to the card's proxy data store. In addition to the estimated balance 520, proxy update module 650 may also write new a status indicator 530 and/or update last use information 540.

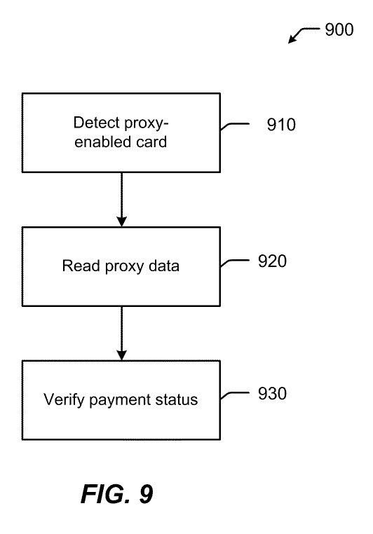

FIG. 9 shows an embodiment of a payment verification process 900 such as can be performed by the verification module 660 of processor 630. At block 910, verification module 660 detects a proxy-enabled card. Verification module 660 may be programmed to identify proxy-enabled cards based bank identifiers or other account information elements such as a particular combination of service code restrictions.

At block 920, verification module 660 reads proxy data from the card. This may include, for example, obtaining last use information 540 as well as other information that is related to payment of services. For example, using card reader 660, a conductor in a transit system may obtain information about the station where a fare was purchased and the time of the purchase. The verification module 660 may also retrieve the current state of transaction counter 560.

Based on the proxy data, at block 930, a determination is made as to status of payments. Among other possibilities, the payment status may indicate that no payment was received, that payment was insufficient, or overpayment for services. In the example of a transit system, a conductor may then request payment of an additional fare or take other appropriate action without the need for a patron to carry a ticket or dedicated fare card.

As will be understood by those skilled in the art, the present invention may be embodied in other specific forms. Those skilled in the art will recognize, or be able to ascertain using no more than routine experimentation, many equivalents to the specific embodiments of the invention described herein. Such equivalents are intended to be encompassed by the following claims.

What is claimed is:

1. A contactless smartcard, comprising:
an antenna adapted to receive magnetic field emissions in a frequency band associated with a card reader; and
an integrated circuit coupled to the antenna and operative to communicate with the card reader according to a contactless smartcard communication protocol, the integrated circuit comprising:
a payment module configured to access account information comprising a bank identification number and to exchange the account information with the card reader in connection with a bank card transaction,
a data store configured to maintain proxy data comprising an estimated account balance corresponding to the account information and at least one data element relating to use of a transit system, and
a proxy module configured to access the proxy data and to update the estimated account balance and the at least one data element in response to commands from the card reader.

2. The contactless smartcard of claim 1, wherein the at least one data element comprises a time of entry and wherein the proxy module is configured to retrieve the time of entry from the data store in response to a card reader command.

3. The contactless smartcard of claim 1, wherein the proxy data is maintained in an encrypted form, and wherein data store comprises one or more cryptographic keys for accessing the proxy data.

4. The contactless smartcard of claim 1, wherein the account information comprises an indicator of an availability of the proxy data.

5. The contactless smartcard of claim 1, wherein the account information is associated with a reloadable bank product.

6. The contactless smartcard of claim 1, wherein the account information comprises track data and wherein the track data is not maintained in the data store.

7. The contactless smartcard of claim 1, wherein the bank identification number is associated with an operator of the transit system.

8. The contactless smartcard of claim 1, wherein the payment module is configured for use with at least one of Visa, MasterCard, American Express, or Discover brand bank cards.

9. The contactless smartcard of claim 1, wherein the contactless smartcard protocol is specified by ISO 14443 standards, and wherein the frequency band associated the card reader comprises 13.56 MHz.

10. A method of accepting contactless smartcards as payment for a transaction at an offline terminal, comprising:
detecting a contactless smartcard at the offline terminal;
obtaining a bank identifier and account information from the contactless smartcard;
obtaining an estimated account balance corresponding to the account information from an updateable storage area of the contactless smartcard;
comparing the estimated account value with a transaction amount; and
determining whether to proceed with the transaction based on a result of the comparison.

11. The method of claim 10, further comprising:
obtaining an updated account balance representing a prepaid account balance associated with the account information; and
writing the updated account balance to the contactless smartcard in connection with the transaction.

12. The method of claim 10, wherein comparing the estimated account value comprises adding the account information to a first list and declining the transaction when the estimated account balance is less than a threshold amount.

13. The method of claim 10, further comprising:
determining a type of the contactless smartcard based on the bank identifier and the account information; and
proceeding with the transaction without the estimated account balance in response to determining that card is associated with a line of credit.

14. The method of claim 10, further comprising:
determining a type of the contactless smartcard based on the bank identifier and the account information;
determining an availability of the estimated account balance; and
declining the transaction in response to determining that the contactless smartcard is a debit-type card and that the estimated account balance is not available.

15. The method of claim 10, further comprising:
obtaining a transaction time corresponding to last use of the contactless smartcard;
comparing the transaction time with transmit system information; and
determining a status of a holder of the contactless smartcard based on a result of the comparison.

16. A card reader, comprising:
a radio-frequency (RF) interface configured to communicate with a contactless smartcard; and
a processor coupled to the RF interface and configured to:
obtain account information comprising a bank identification number from the contactless smartcard,
determine an availability of proxy data at the contactless smartcard and obtain an estimated account balance from the proxy data,
compare the estimated account balance with a transaction amount, and
proceed with the transaction based on a result of the comparison.

17. The card reader of claim 16, further comprising a network interface configured to receive information corresponding to the account information of the contactless smartcard from a host computer, and wherein the processor is configured to determine an estimated balance for the contactless smartcard based on the information received and to update the proxy data at the contactless smartcard with the estimated balance.

18. The card reader of claim 17, further comprising a data storage element, and wherein the processor is configured to receive an updated balance corresponding to the account information using the network interface and to store the updated balance in the data storage element.

19. The card reader of claim 18, wherein the processor is configured to write the updated balance to the proxy data in response to detecting the contactless smartcard.

20. The card reader of claim 19, wherein the processor is configured to change a status of the contactless smartcard in response the updated balance being below a low-balance threshold.

21. The card reader of claim 18, wherein the processor is configured to modify a list in the data storage based on the updated account balance.
